(19) United States
(12) Patent Application Publication
(10) Pub. No.: US 2009/0181630 A1
(43) Pub. Date: Jul. 16, 2009

(54) RADIO FREQUENCY SWITCH CIRCUIT

(75) Inventors: Toshiki Seshita, Kanagawa-ken (JP); Yoshitomo Sagae, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/354,185

(22) Filed: Jan. 15, 2009

(30) Foreign Application Priority Data
Jan. 15, 2008 (JP) 2008-005681
Sep. 25, 2008 (JP) 2008-246660

(51) Int. Cl. H04B 1/18

(52) U.S. Cl. 455/191.3

(57) ABSTRACT

A radio frequency switch circuit includes: an antenna terminal; a first and second RF terminal; a first through transistor placed between the antenna terminal and the first RF terminal; a second through transistor placed between the antenna terminal and the second RF terminal; a first shunt transistor placed between ground and the first RF terminal; a second shunt transistor placed between the ground and the second RF terminal; and a distortion compensation circuit including a reverse parallel connected MOS capacitor whose capacitance around 0 volts has voltage dependence that is convex to the minus direction, the distortion compensation circuit being operable to compensate for voltage dependence of off-capacitance around 0 volts of the first and second through transistor and the first and second shunt transistor that is convex to the plus direction. Electrical connection between the antenna terminal and the first and second RF terminal is switchable.

### CROSS-REFERENCE TO RELATED APPLICATIONS

This application is based upon and claims the benefit of priority from the prior Japanese Patent Application No. 2008-005681, filed on Jan. 15, 2008 and the prior Japanese Patent Application No. 2008-246660, filed on Sep. 25, 2008; the entire contents of which are incorporated herein by reference.

### BACKGROUND OF THE INVENTION

1. Field of the Invention

This invention relates to a radio frequency switch circuit.

2. Background Art

A multi-port radio frequency switch circuit such as an SP5T (single-pole 5-throw) switch is used in multi-mode multi-band wireless equipment. In this case, multi-stage series connected through FETs are provided between an antenna terminal and five RF terminals, and multi-stage series connected shunt FETs are provided between each RF terminal and the ground.

For example, for conduction between the first RF terminal and the antenna terminal, the through FETs and shunt FETs are controlled as follows. The n-stage series connected through FETs between the first RF terminal and the antenna terminal are turned on, and the n-stage series connected shunt FETs between the first RF terminal and the ground are turned off. At the same time, the through FETs between the other RF terminals and the antenna terminal are all turned off, and the shunt FETs between the other RF terminals and the ground are all turned on.

This off-state of n-stage series connected transistors is likely to cause harmonic distortion and higher-order intermodulation distortion based on the nonlinearity of off-capacitance with respect to voltage. In GSM (Global System for Mobile Communications) and UMTS (Universal Mobile Telecommunications System), these distortions need to be reduced to below the system requirements.

JP-T-2005-515657 discloses a technique related to a switch circuit and a method of switching radio frequency signals for use in wireless applications, based on the SOI (silicon-on-insulator) or other technology. This technique provides an RF switch circuit including a first and second switching transistor grouping and a first and second shunting transistor grouping, which allows easy integration.

However, even if this technique is used, it is not easy to reduce harmonic distortion and higher-order intermodulation distortion to meet the requirements of GSM and UMTS without increasing the chip size of the radio frequency switch circuit.

### SUMMARY OF THE INVENTION

According to an aspect of the invention, there is provided a radio frequency switch circuit including: an antenna terminal; a first and second RF terminal; a first through transistor placed between the antenna terminal and the first RF terminal; a second through transistor placed between the antenna terminal and the second RF terminal; a first shunt transistor placed between ground and the first RF terminal; a second shunt transistor placed between the ground and the second RF terminal; and a distortion compensation circuit including a reverse parallel connected MOS capacitor whose capacitance around 0 volts has voltage dependence that is convex to the minus direction, the distortion compensation circuit being operable to compensate for voltage dependence of off-capacitance around 0 volts of the first and second through transistor and the first and second shunt transistor that is convex to the plus direction, electrical connection between the antenna terminal and the first and second RF terminal being switchable.

According to an aspect of the invention, there is provided a radio frequency switch circuit including: an antenna terminal; a first and second RF terminal; a first through transistor placed between the antenna terminal and the first RF terminal; a second through transistor placed between the antenna terminal and the second RF terminal; a first shunt transistor placed between ground and the first RF terminal; a second shunt transistor placed between the ground and the second RF terminal; and a distortion compensation circuit including a reverse parallel connected MOS capacitor and placed at least one of between the antenna terminal and the ground and between the ground and one of the first and second RF terminal, electrical connection between the antenna terminal and the first and second RF terminal being switchable.

According to an aspect of the invention, there is provided a radio frequency switch circuit including: an antenna terminal; a first and second RF terminal; a first through transistor placed between the antenna terminal and the first RF terminal; a second through transistor placed between the antenna terminal and the second RF terminal; a first shunt transistor placed between ground and the first RF terminal; a second shunt transistor placed between the ground and the second RF terminal; and a distortion compensation circuit including a reverse parallel connected MOS capacitor, at least one of the first through transistor, the second through transistor, the first shunt transistor, and the second shunt transistor being connected parallel to the distortion compensation circuit, and electrical connection between the antenna terminal and the first and second RF terminal being switchable.

### BRIEF DESCRIPTION OF THE DRAWINGS

FIG. 1 shows a radio frequency switch circuit according to a first embodiment of the invention;

FIG. 2 is a schematic cross-sectional view of the MOSFET formed on SOI;

FIG. 3 is a graph showing the voltage dependence of the off-capacitance;

FIGS. 4A to 4C are views illustrating the connection of the MOS capacitor constituting the distortion compensation circuit;

FIG. 5 is a graph showing the bias voltage dependence of the gate capacitance;

FIG. 6 is a graph showing the bias voltage dependence of the reverse parallel connected MOS capacitance;

FIG. 7 is a graph showing the input power dependence of the third harmonic distortion of the first embodiment;

FIG. 8 is a graph showing the phase dependence of the third intermodulation distortion of the first embodiment;

FIG. 9 shows a radio frequency switch circuit according to a second embodiment;

FIG. 10 is a graph showing the input power dependence of the third harmonic distortion of the second embodiment;

FIG. 11 shows a radio frequency switch circuit according to a third embodiment;

FIG. 12 is a graph showing the input power dependence of the third harmonic distortion of the third embodiment;

FIG. 13 is a configuration view of a mobile phone including the radio frequency switch circuit;

FIGS. 14A and 14B illustrate a radio frequency switch circuit according to a fourth embodiment;

FIG. 15 is a graph showing the bias voltage dependence of the gate capacitance;

FIG. 16 is a graph showing the bias voltage dependence of the reverse parallel connected MOS capacitance;

FIGS. 17A and 17B are views illustrating the terminal-to-terminal capacitance in the case of one threshold voltage;

FIG. 18 shows a radio frequency switch according to a fifth embodiment;

FIG. 19 shows a radio frequency switch according to a sixth embodiment;

FIGS. 20A and 20B are schematic views showing a first variation of the MOS capacitor;

FIG. 21 is a schematic plan view of the MOSFET; and

FIG. 22 is a schematic plan view of a second variation of the MOS capacitor.

### DETAILED DESCRIPTION OF THE INVENTION

Embodiments of the invention will now be described with reference to the drawings.

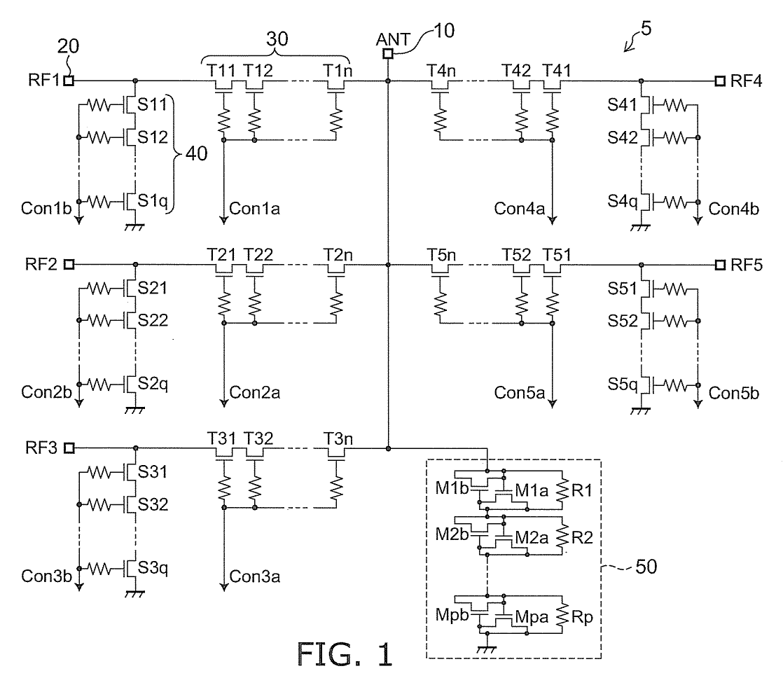

FIG. 1 shows a radio frequency switch circuit according to a first embodiment of the invention. This embodiment illustrates the configuration of an SP5T switch, which can switch the state of conduction (electrical connection) between an antenna terminal 10 and five radio frequency (hereinafter RF) terminals by controlling FETs. Transceiver circuits are connected to at least two RF terminals.

In this embodiment, a distortion compensation circuit 50 is placed between the antenna terminal 10 and the ground. The distortion compensation circuit 50 is composed of a reverse connected MOS capacitor and compensates for nonlinear distortion based on the voltage dependence of off-capacitance Coff in the off-state of FETs. The distortion compensation circuit 50 is described later in detail.

In this example, through FETs (through transistors) 30 placed between the antenna terminal 10 and the first RF terminal (hereinafter RF1 terminal) 20 are turned on, shunt FETs (shunt transistors) 40 placed between the RF1 terminal and the ground are turned off, through FETs placed between the antenna terminal 10 and each of the RF terminals (RF2, RF3, RF4, RF5) except the RF1 terminal are turned off, and shunt FETs placed between the ground and the RF terminals except the RF1 terminal are turned on. Then, conduction can be established between the RF1 terminal and the antenna terminal 10. Normally, switching is performed so that the antenna terminal 10 is electrically connected to one of the RF1-RF5 terminals.

In the case where the FET is a MOSFET, this switching of electrical connection can be controlled by a gate voltage applied from a control signal line to each MOSFET. The gate of the through FET, Tij (i=1, . . . , m, j=1, . . . , n) is connected to a control signal line Conia (i=1, . . . , m) via a high resistance. The gate of the shunt FET, Sij (i=1, . . . , m, j=1, . . . , q) is connected to a control signal line Conib (i=1, . . . , m) via a high resistance. Each control signal line is connected to a control circuit, not shown.

The control circuit illustratively includes a decoder, a negative voltage generation circuit, and a drive circuit. Power consumption can be reduced by using a CMOS structure for the through MOSFETs, the shunt MOSFETs, and the control circuit constituting the radio frequency switch circuit. However, in the conventional bulk CMOS structure, there is a high diffusion capacitance with respect to the Si substrate, and the conductive substrate causes radio frequency transmission loss. Hence, the operation of the radio frequency switch circuit is unsatisfactory. Use of the SOI process is more preferable because it enables rapid operation of MOSFETs.

The through FETs 30 placed between the RF1 terminal and the antenna terminal 10 are configured as n-stage series connected MOSFETs (T1j: j=1, . . . , n). In general, the through FETs placed between the i-th RF terminal and the antenna terminal 10 are n-stage series connected MOSFETs (Tij: i=1, . . . , m, j=1, . . . , n). It is noted that with regard to Tij connected to different RF terminals, the number of series connected stages does not need to be totally uniform.

Likewise, the shunt FETs placed between the i-th RF terminal and the ground are q-stage series connected MOSFETs (Sij: i=1, . . . , m, j=1, . . . , q). Again, the number of series connected stages does not need to be totally uniform. The shunt FETs -can improve isolation of radio frequency signals between the conducting RF terminal and the non-conducting RF terminal.

In an off-state MOSFET, which can be regarded as a nonlinear capacitance, the nonlinearity increases with the increase of the drain-source voltage. Hence, signal distortion due to nonlinearity can be reduced by the n-stage series connection of through MOSFETs (Tij) to decrease the amplitude of voltage applied to one MOSFET by a factor of n, as compared with using one MOSFET. Likewise, signal distortion can be reduced by the q-stage series connection of shunt MOSFETs (Sij). In this figure, the number of series connected stages, n and q, is set to 8, but the invention is not limited thereto. Furthermore, an on-state MOSFET can be regarded as a nonlinear resistance, and again, the nonlinearity increases with the increase of the drain-source voltage.

It is preferable to provide a high resistance (not shown) in parallel between the source and drain electrode of each of the MOSFETs (Tij and Sij) because the operation can be made uniform across the plurality of MOSFETs.

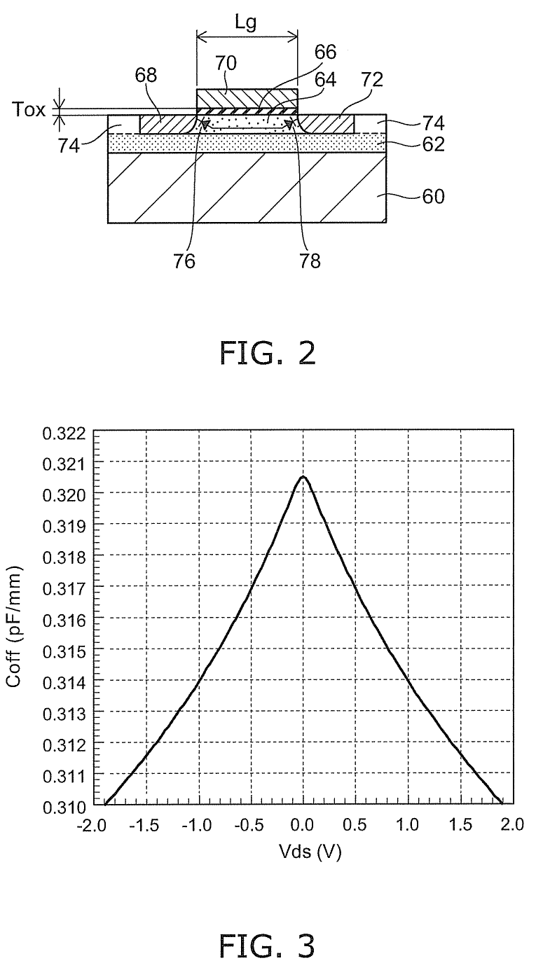

FIG. 2 is a schematic cross-sectional view of the MOSFET formed on SOI used in this embodiment. A buried oxide film layer 62 is formed on a Si substrate 60, and an SOI layer 64, a source region 68, and a drain region 72 are formed on the buried oxide film layer 62. Each MOSFET is isolated by a device isolation layer 74. Furthermore, a gate dielectric film 66 is formed, and a gate electrode 70 is formed thereon. Thus, the MOSFET is realized. In an n-channel structure, in which the SOI layer 64 includes a p-type layer serving as a back gate and n-type layers serving as the source region 68 and the drain region 72, the operating state of the MOSFET can be controlled, for example, between the on-state at a positive gate voltage of not less than a threshold Vth above 0.1 V and the off-state at a gate voltage lower than the threshold Vth.

The fully depleted SOI, in which the thickness of the SOI layer 64 is smaller than the channel depletion depth and the channel portion is depleted, is more preferable because rapid operation can be achieved. It is noted that the MOSFET may have a p-channel structure.

In FIG. 2, for example, the thickness Tox of the gate dielectric film 66 is 9 nm, the gate length Lg is 0.25 μm, and the threshold voltage Vth is 0.35 V. For example, the gate width Wg1 of the through MOSFET (Tij) is 3 mm, and the gate width Wg2 of the shunt MOSFET (Sij) is 0.6 mm, which are taken generally perpendicular to the page. Thus, the size of the shunt MOSFET can be decreased to a fraction of the size of the through MOSFET.

In the SOI layer 64, the neighborhood of the directly underlying portion of the gate electrode 70 is a back gate. A parasitic diode 76 occurs between the back gate and the source region 68, and a parasitic diode 78 occurs between the back gate and the drain region 72. That is, even in the fully depleted type, in the off-state, the gate electrode 70 is negatively biased, and hence the channel is in the accumulation state. Thus, in the off-state, holes occur in the channel layer, and the parasitic diode 76, 78 occurs between the source and the channel and between the drain and the channel. These parasitic diodes 76, 78 have an off-capacitance Coff, which exhibits nonlinearity with respect to the bias voltage.

FIG. 3 is a graph showing the voltage dependence of the off-capacitance Coff. The parasitic diodes 76, 78 are connected to each other in reverse direction to produce the off-capacitance Coff. The vertical axis represents the off-capacitance Coff (pF/mm), and the horizontal axis represents drain-source voltage Vds (V). Even if the drain-source voltage Vds is within a small variation range of approximately ±0.1 V, the off-capacitance Coff significantly varies and produces large signal distortion even in a low power region. Furthermore, the on-resistance of the MOSFET is sufficiently small, and the drain-source voltage Vds is nearly 0 V.

Next, the off-distortion compensation circuit 50 is described.

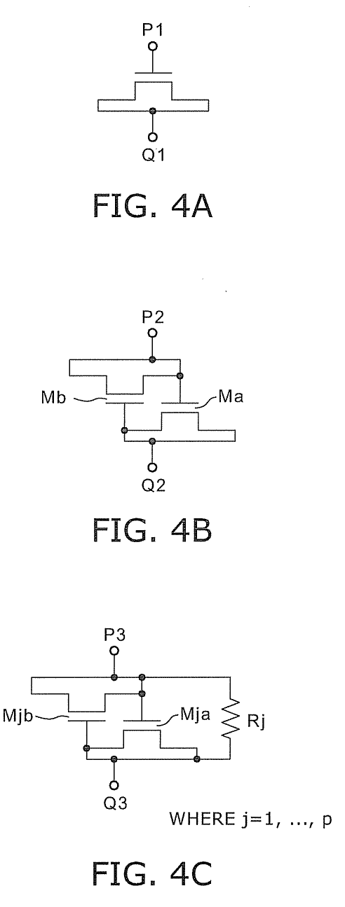

FIG. 4 illustrates the connection of the MOS capacitor constituting the distortion compensation circuit 50. FIG. 4A shows a configuration of the MOSFET of FIG. 2 in which the source region 68 and the drain region 72 are directly connected. FIG. 4B shows a configuration in which the MOSFETs (Ma and Mb) shown in FIG. 4A are parallel connected to each other in reverse direction. FIG. 4C shows a configuration in which a resistance Rj (j=1, . . . , p) is further parallel connected to the MOSFETs (Mja and Mjb) that are parallel connected in reverse direction. In the distortion compensation circuit 50 shown in FIG. 1, the configuration of FIG. 4C is replicated p (p≧1) times to form a p-stage series connection between the antenna terminal 10 and the ground.

Preferably, the resistance Rj is e.g. approximately 10 kΩ to several ten kΩ, because it enables p reverse parallel connected MOSFETs to be operated uniformly. The MOSFETs constituting the distortion compensation circuit 50, the through MOSFETs (Tij), the shunt MOSFETs (Sij), and the resistances Rj can be integrated on the same substrate. They are series connected and parallel connected by interconnect layers, and a small, one-chip radio frequency switch circuit can be implemented.

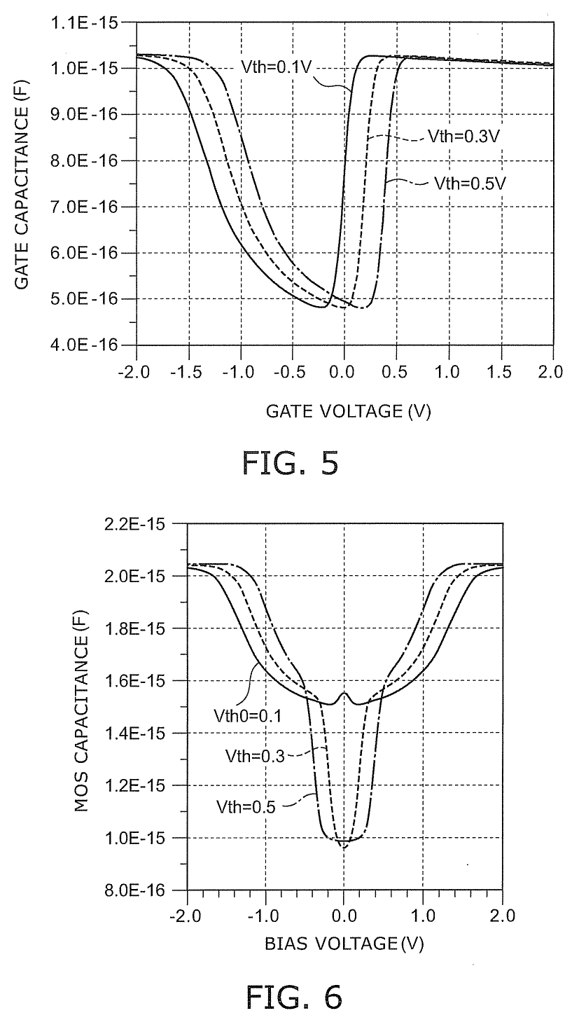

FIG. 5 is a graph showing the bias voltage dependence of the gate capacitance of the MOSFET. The vertical axis represents the gate capacitance (F) between the gate P1 and the junction Q1 between the source region 68 and the drain region 72 as shown in FIG. 4A, and the horizontal axis represents the gate voltage (V). With the increase of the threshold voltage Vth of the MOSFET as 0.1, 0.3, and 0.5 V, the gate voltage minimizing the gate capacitance is shifted to the plus side.

FIG. 6 is a graph showing the bias voltage dependence of the MOS capacitance between the terminal P2 and the terminal Q2 in FIG. 4B. The vertical axis represents the MOS capacitance (F), and the horizontal axis represents the bias voltage (V). By varying the threshold voltage Vth as 0.1, 0.3, and 0.5 V, the bias voltage dependence of the MOS capacitance can be controlled as in this figure. In the case where the threshold voltage Vth is 0.3 and 0.5 V, the voltage dependence of the MOS capacitance can be such that it is minimized around 0 V and has nonlinearity that is convex to the minus direction (downward).

On the other hand, the voltage dependence of the off-capacitance Coff of the MOSFET with respect to the drain-source voltage Vds is maximized around 0 V and has nonlinearity that is convex to the plus direction (upward). Thus, in a desired power region, the nonlinearity of the off-capacitance Coff of the MOSFET can be compensated by using the downward convex nonlinearity of the distortion compensation circuit 50 placed between the antenna terminal 10 and the ground.

In this embodiment, in the MOSFET constituting the distortion compensation circuit 50, the gate oxide film thickness Tox is 9 nm, the gate length Lg is 0.25 μm, and the threshold voltage Vth is 0.35 V, like in the through MOSFET and the shunt MOSFET. On the other hand, the gate width Wg3 is 4 μm, which is different from the gate width Wg1 (3 mm) of the through MOSFET and the gate width Wg2 (0.6 mm) of the shunt MOSFET. The number of series connected stages, p, is set to 8, which is equal to the number of series connected stages of through MOSFETs and shunt MOSFETs, n and q, but the invention is not limited thereto. Preferably, the gate width Wg3 and the number of series connected stages p are optimally adapted to the requirements of the radio frequency switch circuit. It is noted that the reverse connected MOS capacitance can be implemented by connecting the drain and the source of the MOSFET as in FIG. 4. In this case, in the cross section of the MOSFET shown in FIG. 2, one of the drain region 72 and the source region 68 can be omitted.

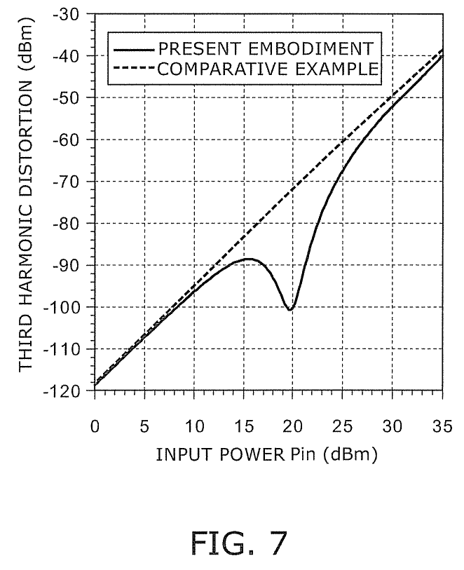

FIG. 7 is a graph showing the input power dependence of the third harmonic distortion of the radio frequency switch circuit according to this embodiment. The vertical axis represents the third harmonic distortion (dBm), and the horizontal axis represents the input power Pin (dBm). In this embodiment, indicated by the solid line, the third harmonic distortion is approximately −101 dBm at an input power Pin of 20 dBm, which satisfies the GSM requirement.

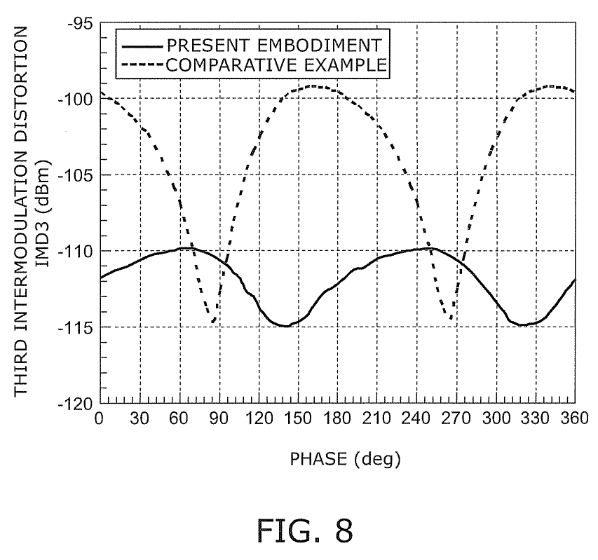

FIG. 8 is a graph showing the phase dependence of third intermodulation distortion. The vertical axis represents the third intermodulation distortion IMD3 (dBm), and the horizontal axis represents phase (deg). In this figure, the transmit power is 20 dBm, and the disturbance power having a frequency of 1.76 GHz is −15 dBm. The phase is given by a phase shifter provided between the radio frequency switch circuit and a duplexer in the transceiver circuit connected thereto. As in this figure, the third intermodulation distortion IMD3 varies depending on the phase between the signal wave and the disturbance wave. In this embodiment, indicated by the solid line, the worst value of the third intermodulation distortion IMD3 is −110 dBm, which satisfies the UMTS requirement.

In the case where a disturbance wave f2 exists near the transmit wave having a frequency of f1, the third intermodulation product having a frequency of 2f1-f2 or 2f2-f1 occurs near the frequency f1 and f2, causes interference, and decreases the communication quality. Hence, this case is unfavorable.

In the case where there are five RF terminals as in FIG. 1, consider the situation in which conduction is established between the RF1 terminal and the antenna terminal 10, whereas the other four RF terminals (RF2-RF5) are non-conducting. Among the through MOSFETs, T1j (j=1, . . . , n) are turned on, but T2j, T3j, T4j, T5j (j=1, . . . , n) are turned off. Furthermore, S1j (j=1, . . . , q) are turned off, but S2j, S3j, S4j, S5j (j=1, . . . , q) are turned on.

In this case, at both ends of on-state T1j (j=1, . . . , n), off-state S1j, T2j, T3j, T4j, T5j are placed between them and the ground. That is, in the multi-port radio frequency switch circuit, there are a large number of off-state MOSFETs electrically connected to the antenna terminal and the RF terminals electrically connected to the antenna terminal 10. Hence, it can be considered that the off-capacitance Coff is dominant in harmonic distortion and higher-order intermodulation distortion.

Furthermore, because the transmit power is sufficiently higher than the receive power, the harmonic distortion and the higher-order intermodulation distortion are higher in the case of transmitting. Moreover, the drain and the source of the MOSFET are normally left-right symmetric with respect to the center line of the gate, and there is little distortion in even orders. Hence, it is practical to aim at reducing third-order distortions such as the third harmonic distortion in FIG. 7 and the third intermodulation distortion in FIG. 8.

The dashed line in FIGS. 7 and 8 represents a radio frequency switch circuit according to a comparative example with no distortion compensation circuit. The configuration other than the distortion compensation circuit is the same as in FIG. 1. In FIG. 7, the third harmonic distortion of the comparative example indicated by the dashed line is −43 dBm at an input power of 33 dBm, which is generally comparable with the GSM requirement, −43 dBm.

On the other hand, the third intermodulation distortion IMD3 of the comparative example indicated by the dashed line is −99 dBm at the worst value. The UMTS requirement dictates that, for example, the third intermodulation distortion IMD3 is −108 dBm or less for a transmit power of 20 dBm and a disturbance power of −15 dBm. Thus, the comparative example does not satisfy the UMTS requirement.

To reduce the third intermodulation distortion IMD3, it may be contemplated to increase the number of series connected stages of through MOSFETs, n, and the number of series connected stages of shunt MOSFETs, q, to reduce the bias voltage applied per MOSFET. In this case, to prevent the insertion loss from increasing, the loss in the conducting state needs to be kept low by increasing the gate width Wg in accordance with the increase of the number of series connected stages n, q. However, this method entails the increase of the chip size of the radio frequency switch circuit, and hence limits the reduction of signal distortion.

If the charge Q(V) accumulated in the off-capacitance Coff can be expressed as a low-order approximation up to the third order using Taylor expansion with respect to the bias voltage V, it should be easy to satisfy both the GSM requirement and the UMTS requirement described above. For example, as a limit satisfying the GSM requirement, consider a radio frequency switch circuit having a harmonic distortion of −43 dBm at a transmit power of 33 dBm. In this case, assuming that the slope of the third harmonic distortion (dBm) with respect to the input power (dBm) is 3, the third harmonic distortion can be determined to be −82 dBm at a transmit power of 20 dBm.

From this, the third intermodulation distortion IMD3 can be calculated by the following formula (in the case where no reflecting wave exists):

IMD3=−82−{20−(−15)}=−117 (dBm)

If a disturbance wave (1.76 GHz) of −15 dBm inputted to the antenna terminal is totally reflected by the duplexer, IMD3 is deteriorated to −111 dBm, but it should still satisfy the UMTS requirement.

However, in practice, as shown in FIG. 3, the drain-source voltage Vds dependence of off-capacitance Coff indicates that Q(V) is difficult to express as a low-order approximation by Taylor expansion, and the slope of the third harmonic distortion (dBm) with respect to the input power (dBm) is smaller than 3. Hence, in practice, it is often the case that the radio frequency switch circuit satisfies the GSM requirement, but does not satisfy the UMTS requirement.

In this embodiment, the distortion compensation circuit 50 can be used to compensate for nonlinearity in the voltage dependence of off-capacitance Coff and reduce the third harmonic distortion and the third intermodulation distortion. The size of the MOSFET constituting the distortion compensation circuit 50 can be made as small as approximately 0.1% of the size of the MOSFET (Tij and Sij) constituting the radio frequency switch circuit, and the chip size can be kept small.

Thus, in FIG. 7, at an input power Pin of 20 dBm, the third harmonic distortion can be improved by approximately 27 dB as compared with the comparative example. Furthermore, in FIG. 8, the worst value of the third intermodulation distortion IMD3 can be improved by approximately 11 dB as compared with the comparative example to −110 dB. Thus, it is easy to satisfy both the GSM requirement and the UMTS requirement. By placing the distortion compensation circuit 50 between the antenna terminal 10 and the ground, the distortion compensation effect can be made generally uniform irrespective of which RF terminal the UMTS transceiver circuit is connected to.

Furthermore, the distortion compensation circuit 50 may be placed between any of the RF terminals and the ground. In this case, placing the distortion compensation circuit 50 between the ground and the RF terminal connected to the UMTS transceiver circuit facilitates satisfying the UMTS requirement.

As an alternative method, it may be contemplated to compensate for unwanted harmonic distortion due to the nonlinear capacitance of off-FETs by using the nonlinear impedance of on-FETs. If the level shift circuit and the active circuit used in this method are integrated into the radio frequency switch circuit, the chip size is increased, and the manufacturing process is complicated. In contrast, this embodiment realizes a simple configuration of the distortion compensation circuit based on passive circuits using a MOS capacitor, which can advantageously simplify the manufacturing process while preventing the chip size from increasing.

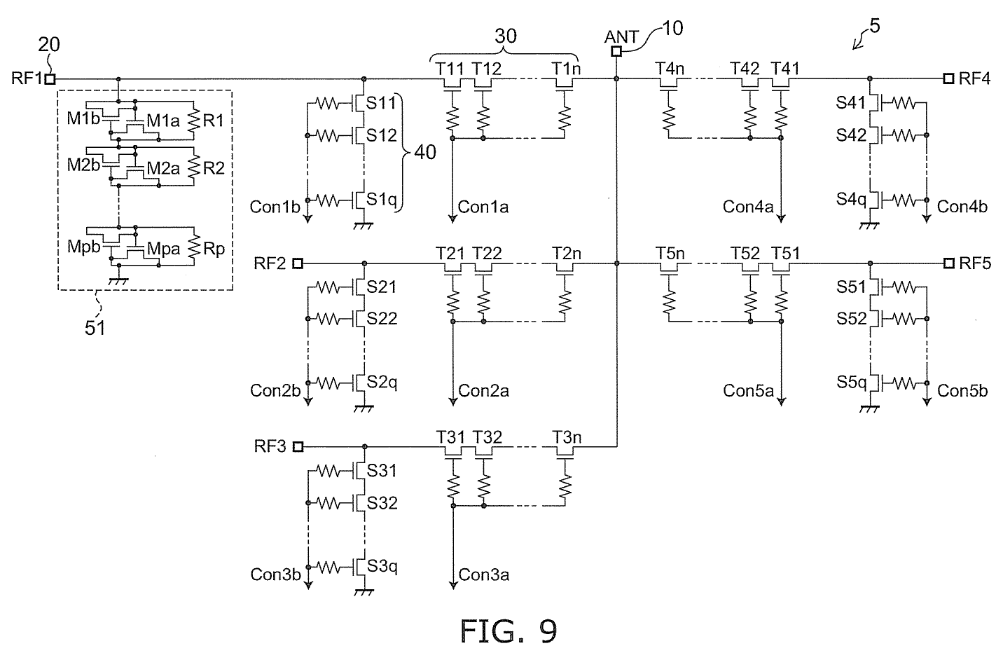

FIG. 9 is a circuit diagram of a radio frequency switch circuit according to a second embodiment. A distortion compensation circuit 51 is placed between the RF1 terminal serving as a GSM transmit terminal and the ground. In this case, in the MOSFET (Mja, Mjb) constituting the distortion compensation circuit 51, the threshold voltage Vth is set to 0.8 V, and the gate width Wg3 is set to 12 μm. This threshold voltage Vth is higher than the threshold voltage Vth of the first embodiment (0.35 V), and the gate width Wg3 is wider than the gate width Wg3 of the first embodiment (4 μm).

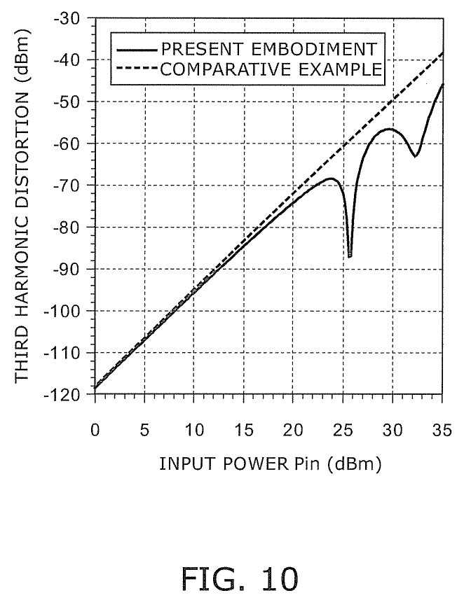

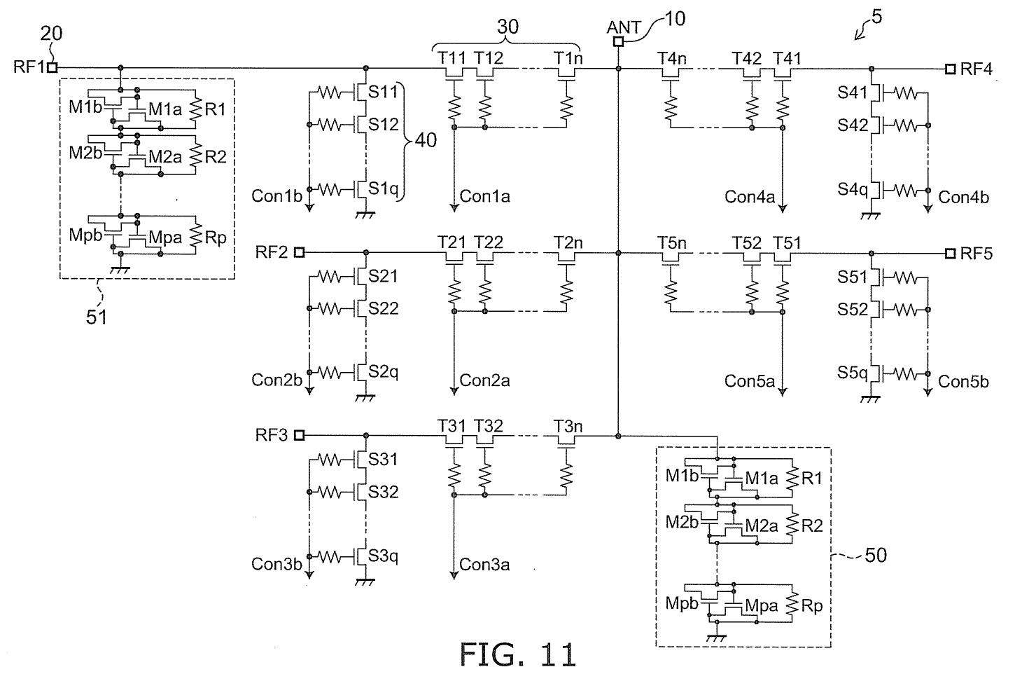

FIG. 10 is a graph showing the input power dependence of the third harmonic distortion of this embodiment. By setting the threshold voltage Vth and the gate width Wg of the MOSFET constituting the distortion compensation circuit 51 as described above, at 33 dBm, which is the GSM maximum transmit power, the third harmonic distortion indicated by the solid line can be improved by 15.7 dB as compared with the comparative example indicated by the dashed line. It is understood that the distortion compensation circuit 51 may be placed between any of the RF terminals and the ground as needed.

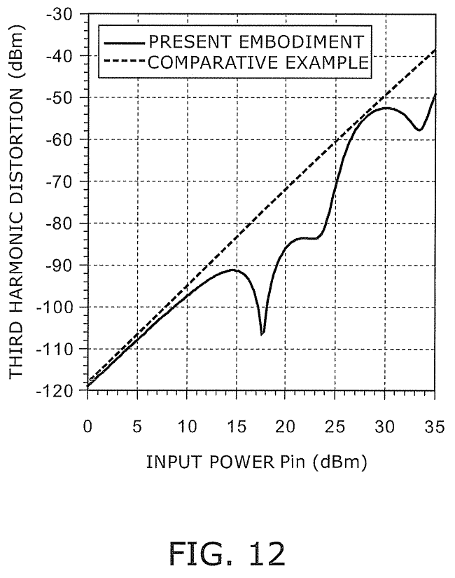

FIG. 11 is a circuit diagram of a radio frequency switch circuit according to a third embodiment. In this embodiment, a first distortion compensation circuit 50 is placed between the antenna terminal 10 and the ground, and a second distortion compensation circuit 51 is placed between the RF1 terminal and the ground. FIG. 12 is a graph showing the input power dependence of the third harmonic distortion in the case where conduction is established between the RF1 terminal and the antenna terminal 10. At an input power Pin of 17 dBm, the third harmonic distortion indicated by the solid line is improved by approximately 30 dB as compared with the comparative example indicated by the dashed line. The input power dependence of the third harmonic distortion in the case where conduction is established between the antenna terminal 10 and any of the RF terminals except the RF1 terminal is the same as FIG. 7.

It is noted that the distortion compensation circuit 50, 51 is not limited to the first to third embodiment. The gate width Wg and the threshold voltage Vth of the MOSFET constituting the distortion compensation circuit 50, 51 can be varied, and the distortion compensation circuit 50, 51 can be suitably placed at one or more of the antenna terminal 10 and the RF terminals.

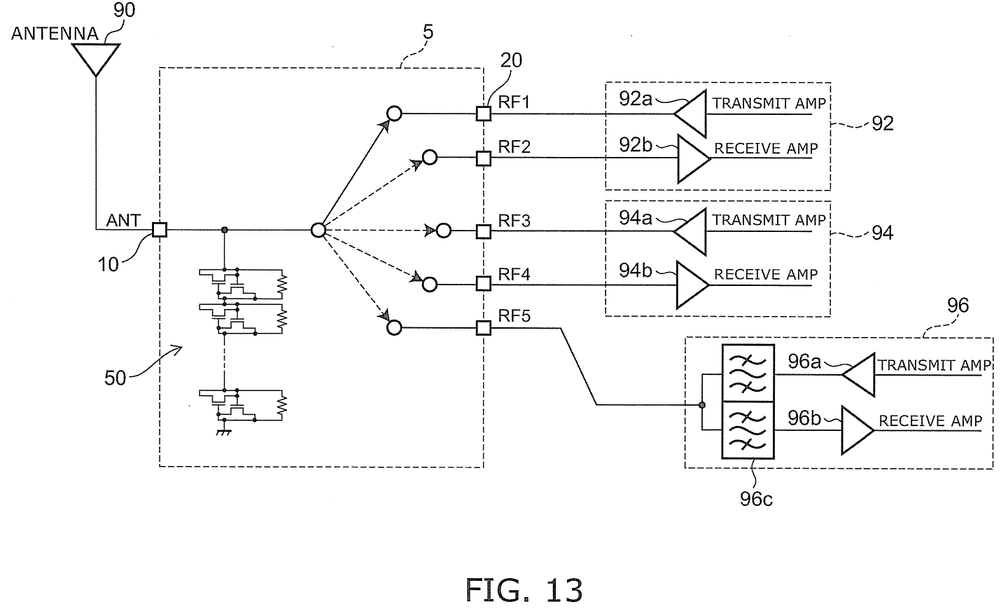

FIG. 13 is a configuration view of a radio frequency section of a mobile phone including the radio frequency switch circuit of this embodiment. An antenna 90 is connected to the antenna terminal 10 of the radio frequency switch circuit 5 including the distortion compensation circuit 50. An output terminal of a transmit amplifier 92a of a GSM low-band (900 MHz band) transceiver circuit 92 is connected to the RF1 terminal, and an input terminal of a receive amplifier 92b thereof is connected to the RF2 terminal. An output terminal of a transmit amplifier 94a of a GSM high-band (1800 MHz band) transceiver circuit 94 is connected to the RF3 terminal, and an input terminal of a receive amplifier 94b thereof is connected to the RF4 terminal.

The UMTS (2 GHz band) transceiver circuit 96 includes a duplexer 96c for splitting transmit/receive signals, a transmit amplifier 96a, and a receive amplifier 96b. By the duplexer 96c, the receive signal from the RF5 terminal is carried to the receive amplifier 96b, and the transmit signal from the transmit amplifier 96a is carried to the RF5 terminal. Using the distortion compensation circuit 50, a radio frequency switch circuit 5 with reduced signal distortion can be realized without increasing the chip size. This illustratively serves to realize a GSM mobile phone with reduced third harmonic distortion and a UMTS mobile phone with reduced third intermodulation distortion, increases the transmission quality of wireless equipment, and facilitates downsizing.

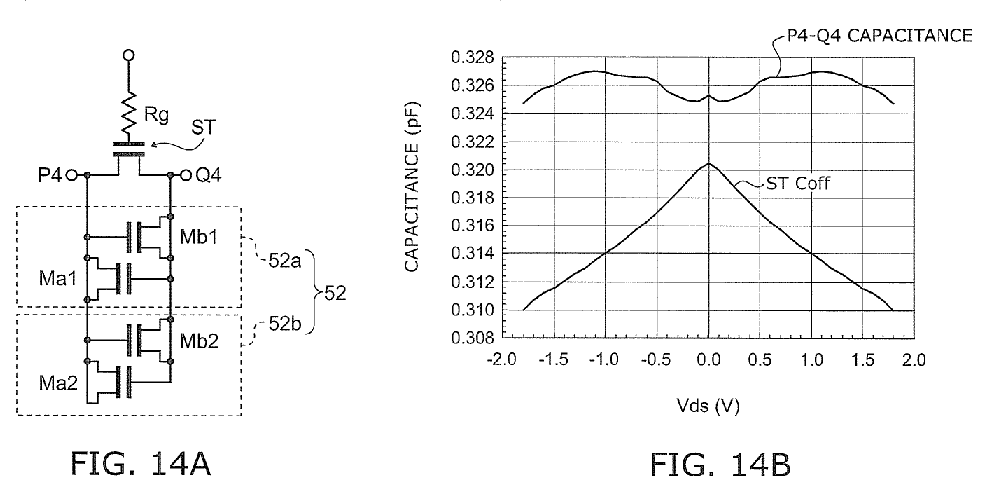

FIG. 14 illustrates a radio frequency switch circuit according to a fourth embodiment. More specifically, FIG. 14A is a connection diagram of a transistor and MOS capacitors, and FIG. 14B shows the drain-source voltage dependence of terminal-to-terminal capacitance. The vertical axis represents capacitance (pF), and the horizontal axis represents the drain-source voltage Vds (V).

A transistor ST and a distortion compensation circuit 52 are parallel connected between the terminal P4 and the terminal Q4. The distortion compensation circuit 52 includes a first MOS capacitor 52a in which MOSFETs having a MOS capacitance are parallel connected to each other in reverse direction, and a second MOS capacitor 52b in which MOSFETs are parallel connected to each other in reverse direction. The transistor ST is series connected and illustratively constitutes the through transistor Tij and the shunt transistor Sij.

If the transistor ST is an N-channel MOSFET, its threshold voltage Vth can be set to generally 0.1 V, for example. The threshold voltage Vth of the MOSFET (Ma1, Mb1) constituting the first MOS capacitor 52a is set to generally 0.2 V, and the threshold voltage Vth of the MOSFET (Ma2, Mb2) constituting the second MOS capacitor 52b is set to generally 0.6 V. Furthermore, the gate electrode of the transistor ST is connected to a control terminal via a resistance Rg of generally 30 kΩ. Conduction can be established between the terminal P4 and the terminal Q4 by setting the voltage of the control terminal to be higher than the threshold voltage Vth of the MOSFET, e.g., to 3 V. The path between the terminal P4 and the terminal Q4 can be interrupted by setting the voltage of the control terminal to be lower than the threshold voltage Vth, e.g., to −2 V.

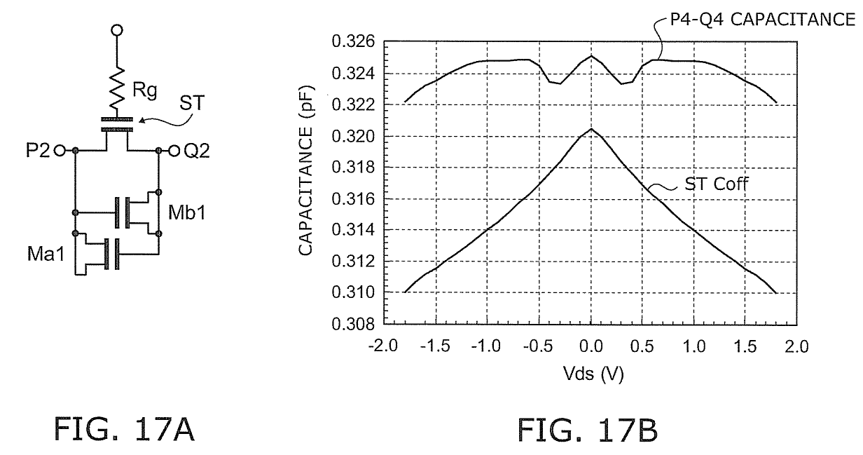

It is assumed that the voltage dependence of the off-capacitance Coff of the transistor ST is generally the same as that shown in FIG. 3. In this embodiment, in the off-state of the transistor ST, the variation of the total capacitance between the terminal P4 and the terminal Q4 can be reduced to generally 2.2 fF in the range of the drain-source voltage Vds from −1.8 to +1.8 V. In a radio frequency switch circuit in which the through transistor consists of one transistor ST, at an input power Pi of 15 dBm, the third harmonic distortion is −51 dBm. On the other hand, without the distortion compensation circuit, the third harmonic distortion at an input power Pin of 15 dBm is −45 dBm, which is reduced by generally 6 dB in this embodiment. Furthermore, in a distortion compensation circuit having one threshold voltage as in FIG. 17A, at an input power Pi of 15 dBm, the third harmonic distortion is −47 dBm. Thus, the fourth embodiment can further reduce the third harmonic distortion.

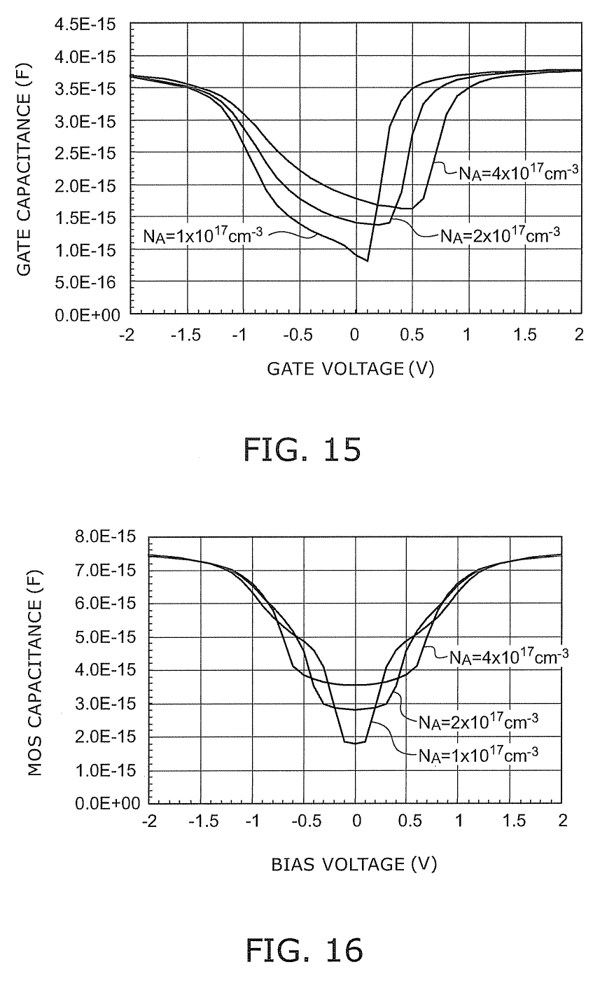

FIG. 15 is a graph showing the voltage dependence of the gate capacitance. The vertical axis represents the gate capacitance (F), and the horizontal axis represents the gate voltage (V).

With the source region and the drain region being grounded, the gate voltage minimizing the gate capacitance is shifted to the plus side with the increase of the channel (B⁺) concentration N_{A} as 1×10¹⁷ cm⁻³, 2×10¹⁷ cm⁻³, and 4×10¹⁷ cm⁻³.

FIG. 16 is a graph showing the bias voltage dependence of the reverse parallel connected MOS capacitance. The vertical axis represents the MOS capacitance (F), and the horizontal axis represents the gate bias voltage (V). With the decrease of the channel concentration N_{A} of the MOSFET, the MOS capacitance around 0 V has steeper nonlinearity that is convex to the minus direction (downward).

In this embodiment, the channel concentration N_{A} is varied to control differently the threshold voltage Vth of the MOSFET constituting the first MOS capacitor 52a and the threshold voltage Vth of the MOSFET constituting the second MOS capacitor 52b. Thus, the characteristics of MOS capacitors having different gate voltage dependences can be combined to further facilitate compensating for the nonlinearity of the off-capacitance Coff of the transistor ST in a desired power range. Furthermore, if the size of the MOS capacitor is varied, it is easier to suitably control the amount of compensation for the off-capacitance Coff.

FIG. 17 illustrates the terminal-to-terminal capacitance in the case of one threshold voltage. More specifically, FIG. 17A is a connection diagram thereof, and FIG. 17B shows the drain-source voltage Vds (V) dependence of the capacitance (pF). In this case, the transistor ST is an N-channel MOSFET with Lg=0.25 μm and Wg1=1 mm. With regard to the MOSFET constituting the MOS capacitor, tₒₓ=9 nm, the channel concentration N_{A}=2×10¹⁷ cm⁻³, Lg=1 μm, and Wg3=1.65 μm. Thus, in the reverse parallel connected MOS capacitor (Ma1 and Mb1), the threshold voltages Vth are both generally 0.6 V. The variation of the off-capacitance Coff of the transistor ST at the gate voltage Vg=−1.5 V is generally 10 fF in the range of the drain-source voltage Vds from −1.8 to +1.8 V.

On the other hand, as in FIG. 16, for example, at the gate voltage around 0 V, a distortion compensation circuit including a MOS capacitor can be used to reduce the MOS capacitance. Thus, the variation width of the total capacitance between the terminal P2 and the terminal Q2 is generally 3 fF. However, the embodiment shown in FIG. 14A is more advantageous in reducing the variation width of the total capacitance and further reducing the third harmonic distortion by using the distortion compensation circuit 52 in which MOS capacitors having at least two different threshold voltages Vth are combined.

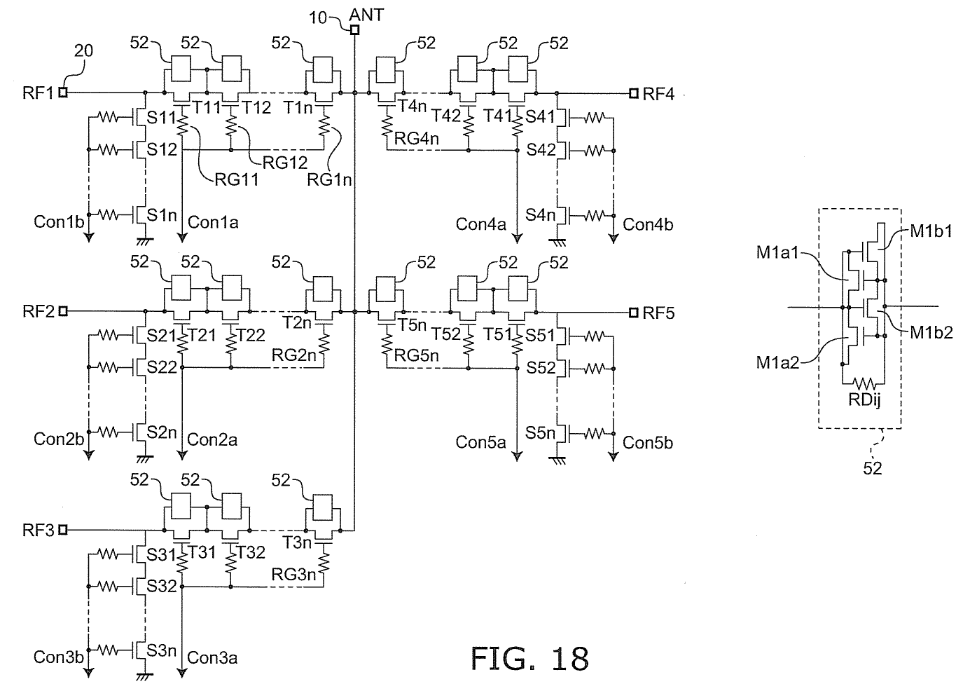

FIG. 18 is a circuit diagram showing a radio frequency switch according to a fifth embodiment.

This embodiment provides an SP5T switch. With regard to the through transistors Tij (i=1, . . . , m, j=1, . . . , n), for example, the threshold voltage Vth is generally 0.1 V, Wg1=4 mm, Lg=0.25 μm, and n=8. The distortion compensation circuit 52 has the configuration of FIG. 14A. That is, the distortion compensation circuit 52 includes a group of MOSFETs (Ma1, Mb1) in which the threshold voltage Vth is generally 0.2 V, Wg3=3.2 μm, and Lg=1 μm, and a group of MOSFETs (Ma2, Mb2) in which the threshold voltage Vth is generally 0.6 V, Wg3=4.8 μm, and Lg=1 μm. It is noted that another group having a different threshold voltage Vth may be included.

This distortion compensation circuit 52 is parallel connected between the drain and the source of each of the eight MOSFETs constituting Tij (j=1, . . . , 8), for example. In each distortion compensation circuit 52, the resistance RDij (i=1, . . . , m, j=1, . . . , n) connected parallel to the first MOS capacitor 52a and the second capacitor 52b can keep generally constant the associated source-drain DC bias of Ti1, . . . , Tin in the off-state. The gate electrode of Tij is connected to the associated control terminal via an associated high resistance RGij (i=1, . . . , m, j=1, . . . , n) so that the connection between the ANT terminal 10 and a desired RF terminal is controllable.

In this case, the through transistors are a series connection of transistors with n=8 and can be operated at a higher input power Pin than with n=1. Thus, for example, the third harmonic distortion is −44 dBm at an input power Pin of 35 dBm. On the other hand, if the distortion compensation circuit is not connected, the third harmonic distortion is −38 dBm, which is reduced by 6 dB in this embodiment. Furthermore, if the distortion compensation circuit consists only of a MOSFET having a threshold voltage Vth of generally 0.6 V as in FIG. 17A, the third harmonic distortion is −40 dBm, which is reduced by generally 4 dB in this embodiment.

In the case where the shunt transistors Sij are turned off, the distortion compensation circuit can be connected parallel to each of the series connected transistors constituting the shunt transistors Sij. In this figure, the number of series connected stages is equal to n for both the through transistors Tij and the shunt transistors Sij, but the invention is not limited thereto.

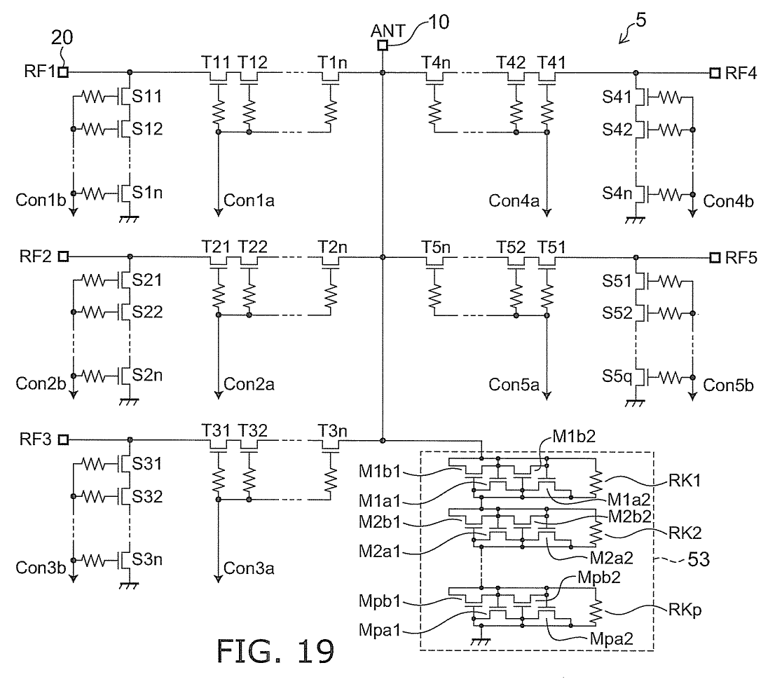

FIG. 19 is a circuit diagram showing a radio frequency switch according to a sixth embodiment.

In this figure, the distortion compensation circuit 53 uses at least two MOSFETs having different threshold voltages Vth. A first MOS capacitor made of MOSFETs that are parallel connected to each other in reverse direction and have a first threshold voltage, a second MOS capacitor made of MOSFETs that have a second threshold voltage, and a high resistance RKj (j=1, . . . , p) are parallel connected. It is noted that two or more MOS capacitors having different threshold voltages may be included.

The distortion compensation circuit 53 is provided between the antenna terminal 10 and the ground and can be a p-stage series connection of the above parallel circuits. It is possible to set p=n. The high resistance RKj can keep generally constant the gate-source voltage of the MOSFET constituting the p-stage series connected MOS capacitors.

In this case, the third harmonic distortion is −44 dBm at an input power Pin of 35 dBm, which is lower than −38 dBm in the case of no distortion compensation circuit and −40 dBm in the case of one threshold voltage. It is noted that the distortion compensation circuit 53 may be placed between any of the RF terminals and the ground.

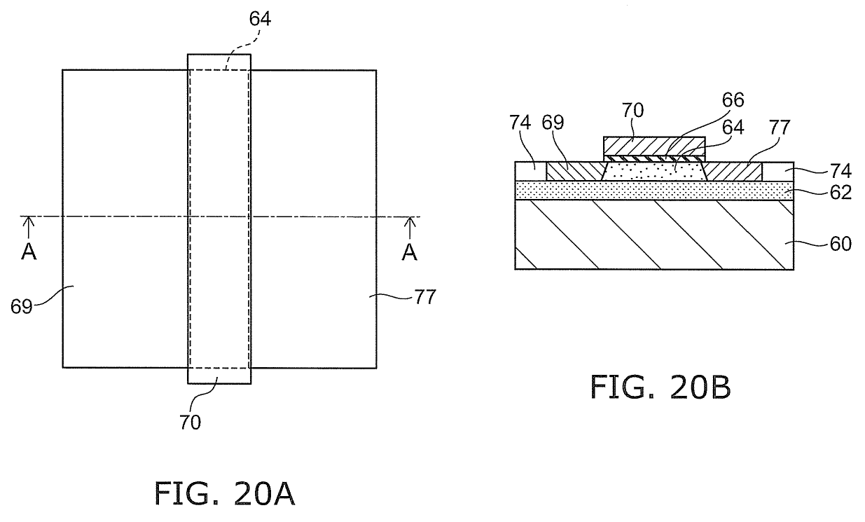

FIG. 20 is a schematic view for illustrating a first variation of the MOS capacitor according to the first to sixth embodiment. More specifically, FIG. 20A is a plan view, and FIG. 20B is a cross-sectional view taken along line A-A.

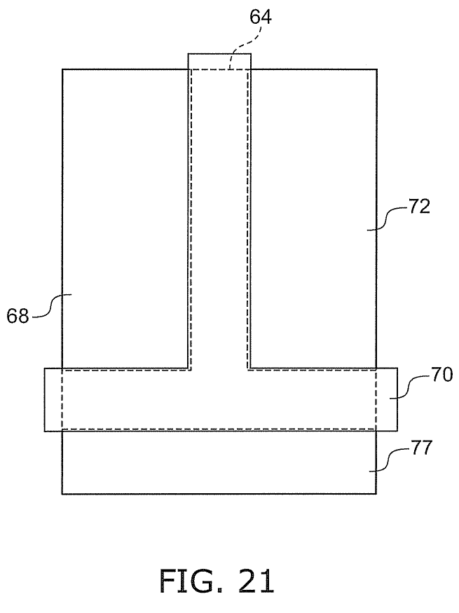

In this variation shown in FIG. 20, the drain region 72 in the MOSFET of FIG. 2 is replaced by a p⁺-type Si layer (extraction region) 77 so that the potential of the body region (back gate) can be extracted. This structure can reduce the planar size as compared with the planar size shown in FIG. 21 while maintaining the operation of the MOS capacitor. In this case, an n⁺-type Si layer 69 is formed on one side of the channel layer formed in the SOI layer 64 below the gate electrode 70, and the p⁺-type layer 77 is formed on the other side. The n⁺-type Si layer 69 and the p⁺-type Si layer 77 can be placed at the same potential by an extraction electrode.

FIG. 21 is a schematic plan view of the MOSFET shown in FIG. 2. In this figure, the potential of the body region (the back gate of the SOI layer 64) is extracted by the p⁺-type Si layer (extraction region) 77 provided in a direction crossing the juxtaposed direction of the source region 68 and the drain region 72, and is connected illustratively to the source region 68.

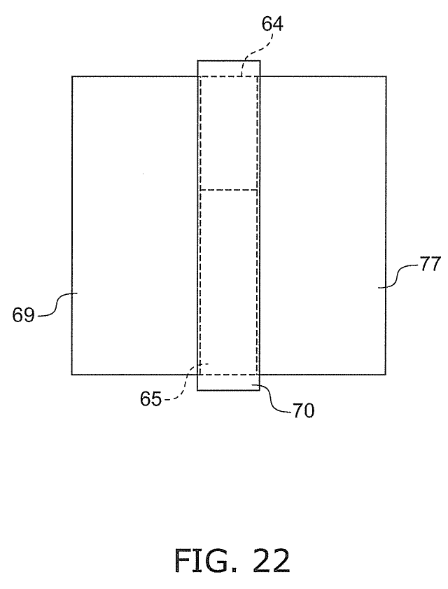

FIG. 22 is a schematic plan view of a second variation of the MOS capacitor. The fourth to sixth embodiment can facilitate compensating for the nonlinearity of the off-capacitance Coff of the through transistor Tij and the shunt transistor Sij by using MOSFETs having different threshold voltages Vth. As in this figure, SOI layers 64, 65 having different carrier concentrations can be used to adjacently provide MOS capacitors having different threshold voltages Vth. Thus, for example, the capacitor Ma1 and the capacitor Ma2 in FIG. 14A can be adjacently provided so that a common gate electrode 70 can be used to reduce the planar size of the distortion compensation circuit.

The first to third, fifth, and sixth embodiment are described with reference to the SP5T switch. However, the invention is not limited thereto, but is applicable to a radio frequency switch circuit generally represented by SPnT (n≧2).

The embodiments of the invention have been described with reference to the drawings. However, the invention is not limited to these embodiments. The size, shape, material, layout and the like of the transistor, MOSFET, MOS capacitor, resistance, SOI, and distortion compensation circuit constituting the radio frequency switch circuit can be variously modified by those skilled in the art, and such modifications are also encompassed within the scope of the invention as long as they do not depart from the spirit of the invention.

1. A radio frequency switch circuit comprising:
an antenna terminal;
a first and second RF terminal;
a first through transistor placed between the antenna terminal and the first RF terminal;
a second through transistor placed between the antenna terminal and the second RF terminal;
a first shunt transistor placed between ground and the first RF terminal;
a second shunt transistor placed between the ground and the second RF terminal; and
a distortion compensation circuit including a reverse parallel connected MOS capacitor whose capacitance around 0 volts has voltage dependence that is convex to the minus direction, the distortion compensation circuit being operable to compensate for voltage dependence of off-capacitance around 0 volts of the first and second through transistor and the first and second shunt transistor that is convex to the plus direction,
electrical connection between the antenna terminal and the first and second RF terminal being switchable.

2. The switch circuit according to claim 1, further comprising:
a third RF terminal;
a third through transistor placed between the antenna terminal and the third RF terminal; and
a third shunt transistor placed between the ground and the third RF terminal,
wherein the radio frequency switch circuit can be used in a multi-band wireless system.

3. The switch circuit according to claim 2, wherein the multi-band wireless system includes at least one of Global System for Mobile Communications (GSM) and Universal Mobile Telecommunications System (UMTS).

4. A radio frequency switch circuit comprising:
an antenna terminal;
a first and second RF terminal;
a first through transistor placed between the antenna terminal and the first RF terminal;
a second through transistor placed between the antenna terminal and the second RF terminal;
a first shunt transistor placed between ground and the first RF terminal;
a second shunt transistor placed between the ground and the second RF terminal; and
a distortion compensation circuit including a reverse parallel connected MOS capacitor and placed at least one of between the antenna terminal and the ground and between the ground and one of the first and second RF terminal,
electrical connection between the antenna terminal and the first and second RF terminal being switchable.

5. The switch circuit according to claim 4, wherein the MOS capacitor includes a first capacitor made of a MOSFET having a first threshold voltage and a second capacitor made of a MOSFET having a second threshold voltage, the first and second capacitor being parallel connected.

6. The switch circuit according to claim 4, wherein
the capacitance of the MOS capacitor has nonlinear voltage dependence that is convex to the minus direction around 0 volts, and
the distortion compensation circuit compensates for nonlinear voltage dependence of off-capacitance of the first and second through transistor and the first and second shunt transistor that is convex to the plus direction around 0 volts.

7. The switch circuit according to claim 4, wherein the distortion compensation circuit includes at least two series connected instances of a parallel circuit made of the MOS capacitor and a resistance.

8. The switch circuit according to claim 4, wherein the antenna terminal and the first RF terminal are electrically connected by turning on the first through transistor, turning off the second through transistor, turning off the first shunt transistor, and turning on the second shunt transistor.

9. The switch circuit according to claim 4, wherein
the first and second through transistor and the first and second shunt transistor are MOSFETs formed on a silicon-on-insulator, and
the MOS capacitor is formed on the silicon-on-insulator.

10. The switch circuit according to claim 9, wherein
the MOS capacitor is made of a MOSFET including a source region of a first conductivity type, a drain region of the first conductivity type, an extraction region of a second conductivity type, a body region of the second conductivity type, a gate dielectric film provided on the body region, and a gate electrode provided on the gate dielectric film, and
the source region and the extraction region are juxtaposed across the body region in a direction that crosses a direction in which the source region and the drain region are juxtaposed across the body region.

11. The switch circuit according to claim 9, wherein the MOS capacitor includes a first region of a first conductivity type, an extraction region of a second conductivity type, a body region of the second conductivity type provided between the first region and the extraction region, a dielectric film provided on the body region, and an electrode provided on the dielectric film.

12. The switch circuit according to claim 11, wherein the body region constituting the MOS capacitor is made of two regions having different carrier concentrations.

13. A radio frequency switch circuit comprising:
an antenna terminal;
a first and second RF terminal;
a first through transistor placed between the antenna terminal and the first RF terminal;
a second through transistor placed between the antenna terminal and the second RF terminal;
a first shunt transistor placed between ground and the first RF terminal;
a second shunt transistor placed between the ground and the second RF terminal; and
a distortion compensation circuit including a reverse parallel connected MOS capacitor,
at least one of the first through transistor, the second through transistor, the first shunt transistor, and the second shunt transistor being connected parallel to the distortion compensation circuit, and
electrical connection between the antenna terminal and the first and second RF terminal being switchable.

14. The switch circuit according to claim 13, wherein at least one of the first through transistor, the second through transistor, the first shunt transistor, and the second shunt transistor includes at least two series connected transistors that are connected parallel to the distortion compensation circuit.

15. The switch circuit according to claim 13, wherein the MOS capacitor includes a first capacitor made of a MOSFET having a first threshold voltage and a second capacitor made of a MOSFET having a second threshold voltage, the first and second capacitor being parallel connected.

16. The switch circuit according to claim 13, wherein
the capacitance of the MOS capacitor has nonlinear voltage dependence that is convex to the minus direction around 0 volts, and
the distortion compensation circuit compensates for nonlinear voltage dependence of off-capacitance of the first and second through transistor and the first and second shunt transistor that is convex to the plus direction around 0 volts.

17. The switch circuit according to claim 13, wherein the distortion compensation circuit includes at least two series connected instances of a parallel circuit made of the MOS capacitor and a resistance.

18. The switch circuit according to claim 13, wherein the antenna terminal and the first RF terminal are electrically connected by turning on the first through transistor, turning off the second through transistor, turning off the first shunt transistor, and turning on the second shunt transistor.

19. The switch circuit according to claim 13, wherein
the first and second through transistor and the first and second shunt transistor are MOSFETs formed on a silicon-on-insulator, and
the MOS capacitor is formed on the silicon-on-insulator.

20. The switch circuit according to claim 19, wherein the MOS capacitor includes a first region of a first conductivity type, an extraction region of a second conductivity type, a body region of the second conductivity type provided between the first region and the extraction region, a dielectric film provided on the body region, and an electrode provided on the dielectric film.
